(19) United States
(12) Patent Application Publication
(10) Pub. No.: US 2011/0090397 A1
(43) Pub. Date: Apr. 21, 2011

(54) METHOD AND APPARATUS FOR DYNAMIC DISPLAYS FOR DIGITAL CINEMA

(76) Inventors: William Gibbens Redmann, Glendale, CA (US); Kerry M. Perkins, Simi Valley, CA (US)

(21) Appl. No.: 12/737,228

(22) PCT Filed: Jun. 30, 2008
(86) PCT No.: PCT/US2008/008166

§ 371 Date: Dec. 20, 2010

(51) Int. Cl. H04N 7/00

(52) U.S. Cl. 348/468; 348/E07.001

(57) ABSTRACT

A method and apparatus for dynamic displays for digital cinema, generates (520) dynamic information for display by processing a subtitle file including at least one element related to the dynamic information.

### TECHNICAL FIELD

The present principles relate generally to digital cinema and, more particularly, to a method and apparatus for dynamic displays for digital cinema.

### BACKGROUND

Before a motion picture presentation, it is common to run a pre-show that includes a mixture of advertisements and trailers for future presentations.

Many patrons of theaters, desirous of popcorn, soda, and other comestibles advertised during the pre-show interval forgo such pleasures out of the fear of missing the beginning of the movie. It is desirable, therefore, that an indication be provided in advance of the feature presentation to indicate just how much time remains before the show begins. In this way, patrons may queue for refreshments without undue fear of being forever ignorant of key plot points.

It is also the case that exhibitors may wish to provide personalized messages as a service, for example to members of the audience celebrating a birthday or anniversary.

Presently there is no mechanism to indicate to theater patrons how long until a show starts, except by careful, manual intervention in the construction of the show playlist. More generally, there are no systems that dynamically update individual screens planned for a presentation.

### SUMMARY

These and other drawbacks and disadvantages of the prior art are addressed by the present principles, which are directed to a method and apparatus for dynamic displays for digital cinema.

According to an aspect of the present principles, there is provided a method for use in a digital display system. The method includes generating dynamic information for display by processing a subtitle file including at least one element related to the dynamic information.

According to another aspect of the present principles, there is provided an apparatus for use in a digital display system. The apparatus includes a display manager for generating dynamic information for display by processing a subtitle file including at least one element related to the dynamic information.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 is a block diagram of a digital cinema presentation system in a theatrical auditorium providing a dynamically generated display, in accordance with an embodiment of the present principles;

FIG. 2 is a schematic diagram of a show playlist, the composition playlists the show playlist references, the track and asset file components which are referenced by the dynamic content composition, and a timeline indicating important events relative to the generation and display of dynamic content, in accordance with an embodiment of the present principles;

FIG. 3 is a diagram showing an exemplary composition, in accordance with an embodiment of the present principles;

FIG. 4A shows an exemplary subtitle track file making use of timed text, in accordance with an embodiment of the present principles;

FIG. 4B shows a portion of an alternative exemplary subtitle track file making use of timed text, in accordance with an embodiment of the present principles;

FIG. 4C shows a portion of an alternative exemplary subtitle track file making use of dynamic sub-pictures, in accordance with an embodiment of the present principles; and

FIG. 5 is a flow diagram of an exemplary method for displaying dynamic information in a digital display system, in accordance with an embodiment of the present principles.

### DETAILED DESCRIPTION

The present principles are directed to a method and apparatus for dynamic displays for digital cinema.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “NB”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed. Furthermore, “one or more elements” and “at least one element” are used interchangeably.

Moreover, it is to be appreciated that while one or more embodiments of the present principles are described herein with respect to particular types of elements (e.g., HTTP servers), data formats, programming languages, message types, message contents, and so forth, the present principles are not limited to solely these particular types of elements, data formats, programming languages, message types, message contents, and so forth, and, thus, may be utilized with respect to other types of elements, data formats, programming languages, message types, message contents, and so forth, while maintaining the spirit of the present principles.

As noted above, the present principles are directed to a method and apparatus for dynamic preshow displays for digital cinema. For example, one or more embodiments allow for dynamically providing information to a cinema audience, particularly in relationship to a current show (e.g., one currently playing or about to be played) in the cinema. As one example, such information may include, but is not limited to, specifying how many minutes remain until show time, real-time news, weather, sports score updates, and so forth.

The advent of digital cinema systems provides an opportunity to introduce a new functionality into theatrical presentations. A composition playlist (CPL) is inserted Into a show playlist (SPL) such as those supported by widely available digital cinema servers. The composition playlist uses a mechanism normally reserved for retrieving a subtitle element to describe dynamically defined timed text, and/or to retrieve still images dynamically created in accordance with the present principles, among others.

An exemplary use envisioned is for the creation of a “time remaining until the feature” message, and a dynamically created countdown. Additional exemplary uses include the creation of real-time news updates such a current sports scores, and theater status updates such as “the concession lines are short”, “the show is delayed”, among others.

Additionally, personalized or customized messages can be displayed, such as “Happy Birthday, Kerry!” or “Please Marry Me, Rondi!”. Such messages can help promote a cinema outing for special occasions.

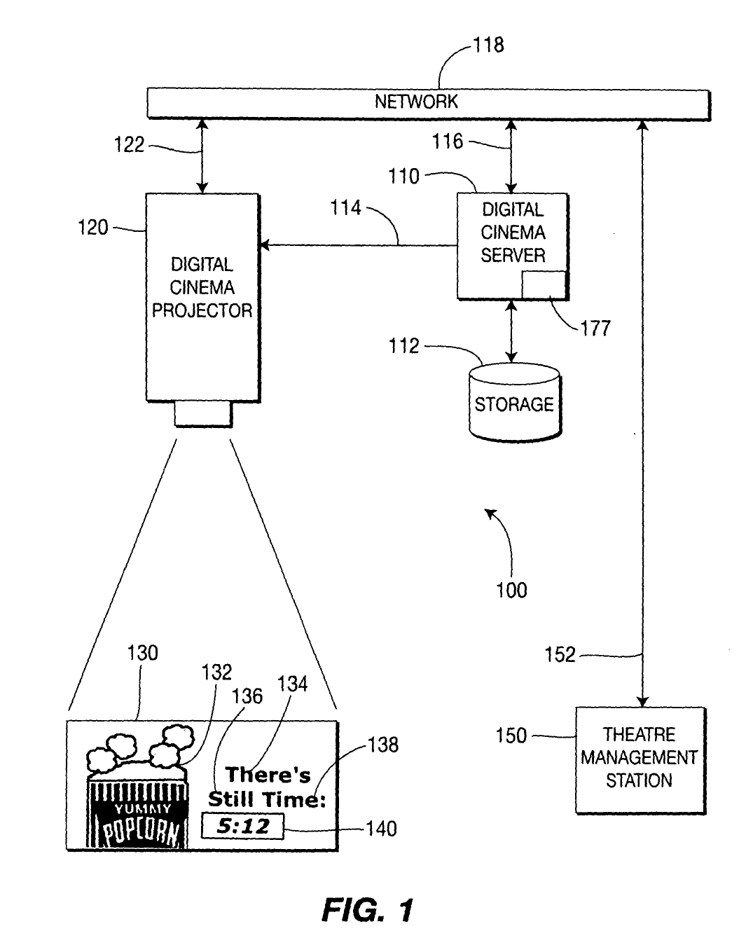

Referring to FIG. 1, a digital cinema system 100 for presentation on screen 130 is shown. It is to be appreciated that any specific reference to a particular manufacturer and/or model with respect to any of the elements of FIG. 1 is for illustrative purposes and, thus, the present principles are not limited to the same. Given the teachings of the present principles provided herein, one of ordinary skill in this and related arts will contemplate these and various other manufacturers and models, as well as other elements (including substitutions, additions, and omissions) and other configurations, while maintaining the spirit of the present principles.

The digital cinema system 100 includes digital cinema server 110, a storage device 112 and digital cinema projector 120. Server 110 and projector 120 are interconnected, preferably as described below.

An example of server 110 is the DCP-2000 by DOREMI LABS, INC. of Burbank, Calif. An example of projector 120 includes many of those based on the Texas Instruments DLP Cinema® light engine, such as the STARUS NC2500S by NEC Corporation of America, of Santa Clara, Calif.

Digital cinema system 100 also preferably includes audio equipment (not shown) suitable for reproducing a sound track in the auditorium of screen 130.

Server 110 has a connection 116 to network 118. Projector 120 has a connection 122 to network 118. Server 110 and projector 120 are in communication through connections 118 and 122. Network 118 may be implemented as, for example, a 100bT Ethernet network.

Server 110 also has a connection 114 to projector 120 through which, during playout, an image stream is provided to projector 120. Connection 114 may be implemented as, for example, a dual high definition serial digital interface (dual HD-SDI).

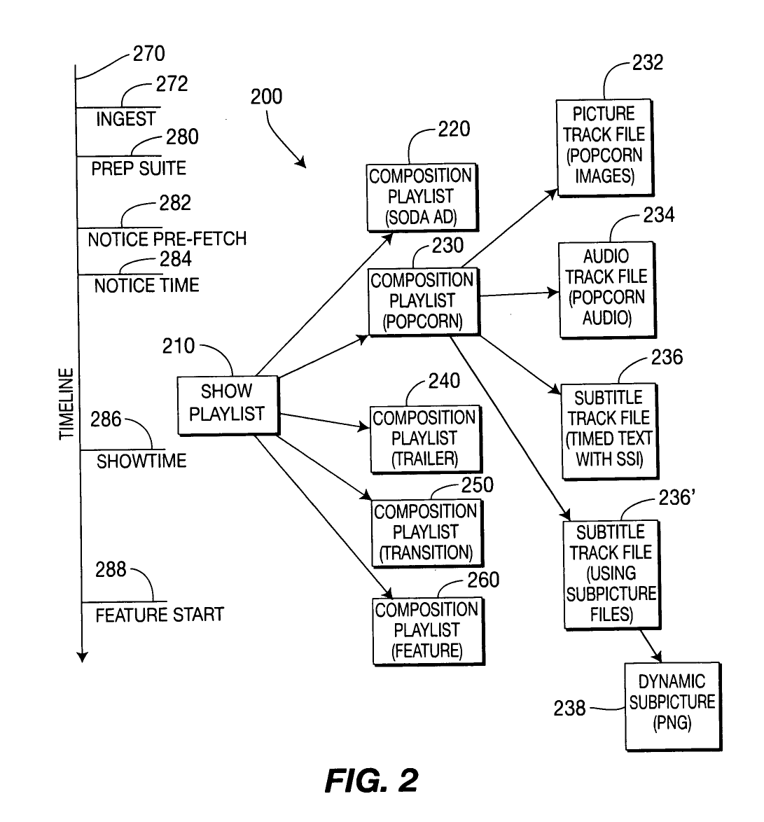

Projector 120 is arranged to make a projection on screen 130. When the present principles are in use, the projection on screen 130 may include, for example, but is not limited to, an image 132 such as a tempting image of delicious popcorn, a text message including words 134, 136, and 138, and a display 140 of time remaining. The source of presentation elements 132, 134, 136, 138, and 140 is described in further detail below, in conjunction with FIGS. 2, 3, 4A-C.

At least the display of time remaining 140 is dynamic content, preferably provided by server 110 to projector 120, for the projection on screen 130.

The storage device 112 includes digital cinema content, and may be connected directly to server 110 (as shown) or may be accessed through network 118 (network access not shown). This content is further described below.

A theater management station (TMS) 150 having a connection 152 to network 118 can be used by theater personnel for controlling and monitoring server 110 and projector 120. Alternatively, a projectionist can directly control and operate server 110 and projector 120 through dedicated user interfaces (not shown).

A display manager 177 manages the displaying of dynamic text and/or other information (e.g., graphics, and so forth), also collectively referred to herein as “dynamic information”, in accordance with the present principles. In the embodiment shown, display manager 177 is implemented in digital server 110. In another embodiment, display manager 177 could be implemented as a stand-alone apparatus having communication with digital server 110, for example through network 118. In still another embodiment, display manager 177 could reside on theater management system 150. In still another embodiment, display manager 177 may be a distributed entity, for example, with components on both digital server 110 and theater management system 150.

The display manager 177, in conjunction with the server 110 and/or other components in system 100, provides at least one subtitle file that includes at least one element relating to the dynamic information, and during or shortly before playout of a show playlist (to be discussed in conjunction with timeline 270 in FIG. 2), dynamically resolves the at least one element and reproduces (e.g., visually and/or audibly) the dynamic information (for example, on screen 130, and/or another screen(s). It is to be appreciated that while referred to as a “display manager”, in one or more embodiments, display manager 177 may simply reproduce audio information (e.g., “the movie will begin in 10 minutes”). However, it is preferable that the display manager 177, at the least, manages the reproduction (display) of image/video data in various embodiments in accordance with the present principles.

Alternatively, the display manager 177 may also be configured for receiving at least one user input relating to the dynamic information, which contains customized or personalized information or messages to be reproduced on screen 130 and/or one or more other screens and/or one or more speakers (not shown, and may or may not be integrated with the screens). Thus, it may be advantageous to configure the display manager 177 as a distributed entity that includes a user interface at the theater management station 150 for receiving customized information.

The storage device 112 includes show data 200. Preferably, but not necessarily, the show data 200 includes files in accordance with the corresponding file formats described by the Society of Motion Picture and Television Engineers (SMPTE) of White Plains, N.Y., in their published and emerging standards:

| | |
|---|---|
| D-Cinema Packaging - Sound & Picture Track File | 429-3 |
| D-Cinema Packaging - MXF JPEG 2000 Application | 429-4 |
| D-Cinema Packaging - MXF Timed-Text Track File | 429-5 |
| D-Cinema Packaging - MXF Track File Essence Encryption | 429-6 |
| D-Cinema Packaging - Composition Playlist | 429-7 |
| D-Cinema Operations - Show Playlist | 430-8 |

However, prior to these standards being widely adopted, other file formats, including manufacturers' proprietary formats may be used. For instance, Texas Instruments, Inc. of Dallas, Tex. today supports a subtitle track file format upon which SMPTE 429-5 (above) was based. Manufacturers of digital cinema servers such as the exemplary one previously mentioned by DOREMI LABS have a proprietary show playlist format. Thus, it is to be appreciated that the present principles are not limited to any particular file format.

Referring to FIG. 2, a schematic diagram is shown of a show playlist, the composition playlists referenced by the show playlist, the track and asset file components referenced by the dynamic content composition, and a timeline indicating important events relative to the generation and display of dynamic content. Furthermore, the composition playlists 220, 230, 240, 250 and 260 are meant to correlate in time with the various events indicated along the timeline.

As the time for playout approaches, the show data 200 is structured as follows: the show playlist 210 lists each composition that can play. In some versions of the show playlist, there may be one or more levels of indirection through files that collect compositions into convenient groups (not shown), but the indirection is resolvable to a sequence of compositions such as represented by composition playlists (CPLs) 220, 230, 240, 250, and 260. In this example, CPL 220 is an advertisement for soda, CPL 230 is a dynamic ad for popcorn, CPL 240 is a trailer for an upcoming movie release, CPL 250 is a transitional element which, in a showmanly manner, for example, concludes the pre-show and prepares the audience for the feature presentation, and CPL 260 is the main attraction (i.e., the feature itself). While an actual preshow would generally have more ads, more trailers, and additional transitional elements (e.g., a “coming soon” element before the trailers), the CPLs shown are representative.

While each of the CPLs will generally reference picture and audio track files, and some of the CPLs may reference a subtitle track file, with the composition described by each CPL including associated track files, these associations are only shown for CPL 230 for the sake of brevity.

The CPL 230 enumerates three track files, picture track file 232, audio track file 234, and subtitle track file 236. In an alternative embodiment discussed below, subtitle track file 236′ references instead of subtitle track file 236.

The picture track file 232 provides the data necessary to display tempting images of delicious popcorn 132. Picture track file 232 is retrieved by server 110 from storage 112, decoded into an image signal which is transmitted via connection 114 to projector 120. Projector 120 formats the image signal as needed, and the corresponding images, after additional processing for the subtitles, are displayed.

The audio track file 234 provides the data necessary to provide an audio track in synchronization with the display of picture track file 232.

The subtitle track file 236 or 236′ provides a subtitle sequence that is overlaid with the images provided from picture track file 232. Words 134, 136, and 138 appear over time, but are preferably statically encoded in subtitle track file 236 or 236′. Time remaining 140 is dynamically provided during the processing of subtitle track file 236, or during the processing of dynamic subpicture 238 referenced by subtitle track file 236′.

In the parlance of digital cinema subtitles, a distinction is made between “timed text” and “subpicture” subtitles. “Timed text” describes subtitles that are provided as text and fonts with the text being rendered using the fonts into a subtitle image that will be overlaid in synchronization with the images provided by the picture track file 232. “Subpicture” describes subtitles that are provided as still image files, typically in the portable network graphics (PNG) file format, such as a still image of the time remaining 140. An advantage of the subpicture approach is that a graphical image of a clock showing the time remaining (not shown) could be used in lieu of a numeric display shown as time remaining 140.

The timeline 270 includes a series of events arranged with time advancing in the direction of the arrow.

At ingest time 272, a time preferably well in advance of playout, the various elements of the show are copied to the storage device 112, preferably under the control of server 110 or a similarly trusted entity. During ingest, a CPL is provided to server 110 along with each of the track files which the CPL references.

As a well-known matter of security, reliability, and quality control, the CPL preferably includes a hash value corresponding to each of the track files that is derived from the corresponding track file. By re-deriving a current hash value for each of the track files and comparing the value to a value stored in the CPL, server 110 is assured that the files are complete, have not been miscopied, nor subjected to tampering. The presence of the hash value within the CPL is optional.

Prep-suite time 280 occurs shortly before playout begins, e.g., within about 30 minutes. Showtime 286 is preferably the published show time, which is generally a few minutes before the start of the feature, but in no case should it be any later than the start of the feature. Feature start time 288 is the time when the feature actually commences.

Shortly before playout begins, at prep-suite time 280, the server 110 prepares for imminent playout of the performance described by show playlist 210. Communication between projector 120 and server 110 across network 118 is established and confirmed. The presence of current, valid decryption keys (not shown) is confirmed for any CPL identified by show playlist 210 that requires decryption keys. Depending on the implementation, the server 110 may buffer a quantity of picture and audio data to allow for a rapid onset of playout when triggered. Also, projector 120 may be provided with listing of subtitle track files, such as subtitle track file 236, that will appear in show playlist 210. Preferably, the subtitle track file 236 is not transferred to projector 120 at this time.

At some point, preferably within 30 minutes of prep-suite time 280, playout begins and content described by CPLs such as soda ad 220 is presented on screen 130 in the auditorium.

Preferably notice prefetch time 282 occurs a few moments before notice time 284, the time when CPL 230 begins its playout, and projector 120 requests track file 236 (or in an alternative embodiment, track file 236′) from server 110 through network 118.

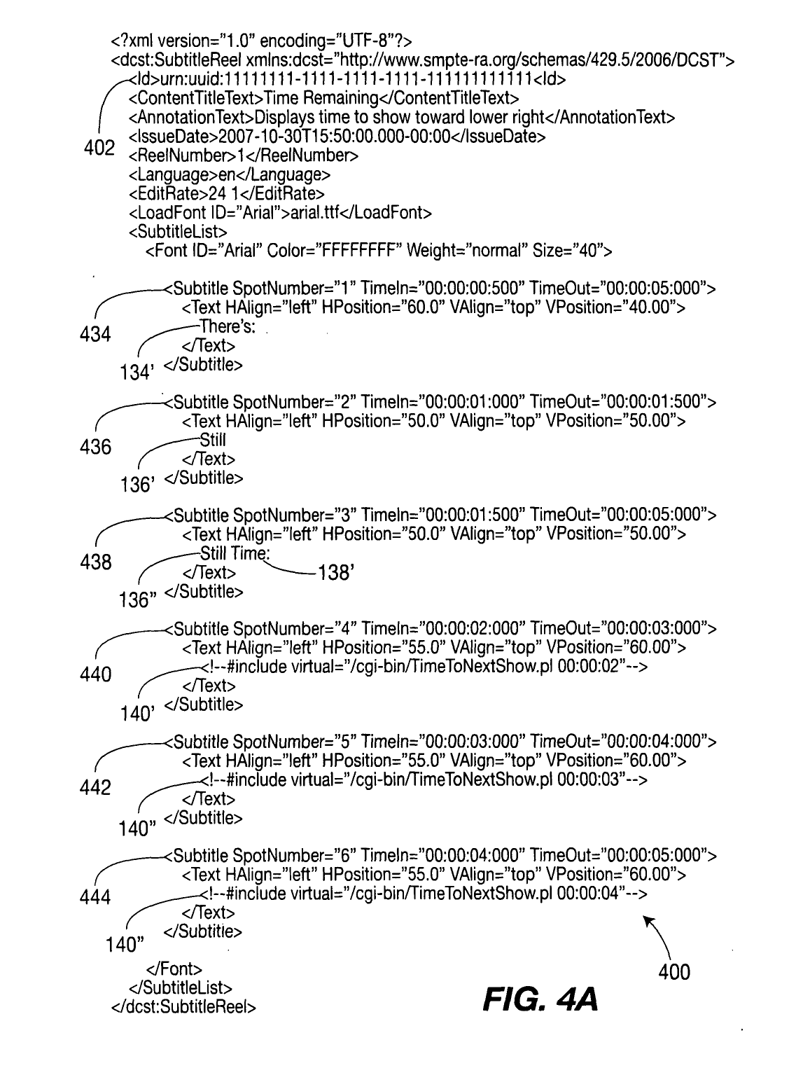

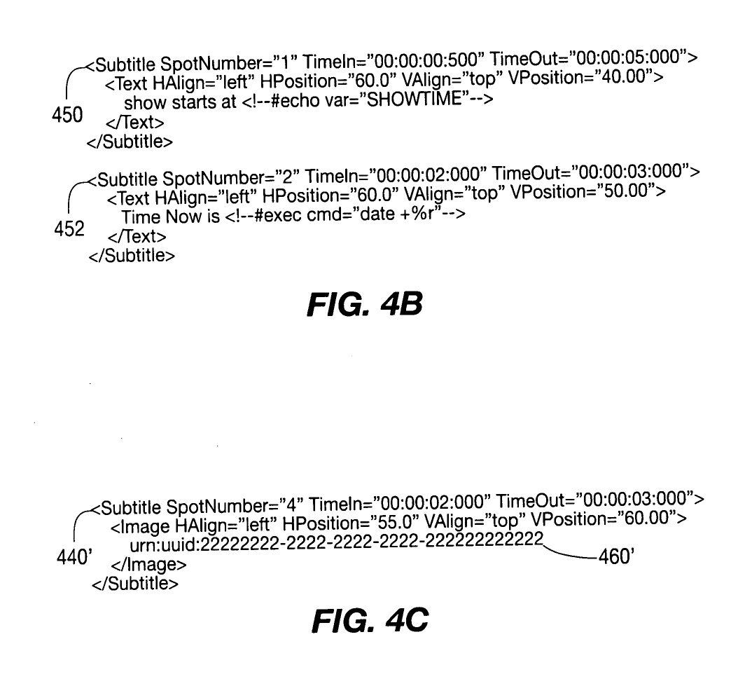

At notice prefetch time 282, subtitle track file 236 is processed by server 110 and any dynamic text callout (described in more detail below), for example as may be implemented using “server-side includes” (the processing being performed by the display manager 177, which, in a preferred embodiment, comprises an HTTP server on digital cinema server 110 provisioned to interpret the server-side includes), is replaced by appropriate text values. This substitution may be made with a predetermined expectation of the interval between notice prefetch time 282 and notice time 284, the current time, showtime 286, and feature start time 288, or similar information as parameters. These times may be expressed in absolute clock time, or may be expressed as a time relative to the beginning of the show playlist, or other convenient reference. These, or other parameters, may be combined by a predetermined algorithm to return the substitution text. Several exemplary algorithms are described below in conjunction with FIGS. 4A and 4B.

In an implementation using subtitle track file 236′ having a reference to a subpicture 238, projector 120 will request the subpicture 238 from server 110 shortly before the point at which it is needed for display according to subtitle track file 236′. In this case, the PNG image file returned in response to the request by projector 120 will be created or selected dynamically by server 110 according to a predetermined algorithm known to server 110 and associated with the identification in subtitle track file 236′ by which projector 120 refers to subpicture file 238. This dynamic subpicture file generating or selecting algorithm may accept any of the parameters mentioned above and behaves similarly to the exemplary algorithms described in conjunction with FIGS. 4A and 4B, though executed in response to a request induced, for example, in conjunction with FIG. 4C.

At the conclusion of playout of the dynamic composition identified by CPL 230, playout continues according to SPL 210 with a trailer, a transition, and the feature, with the corresponding compositions identified by CPLs 240, 250, and 260 respectively.

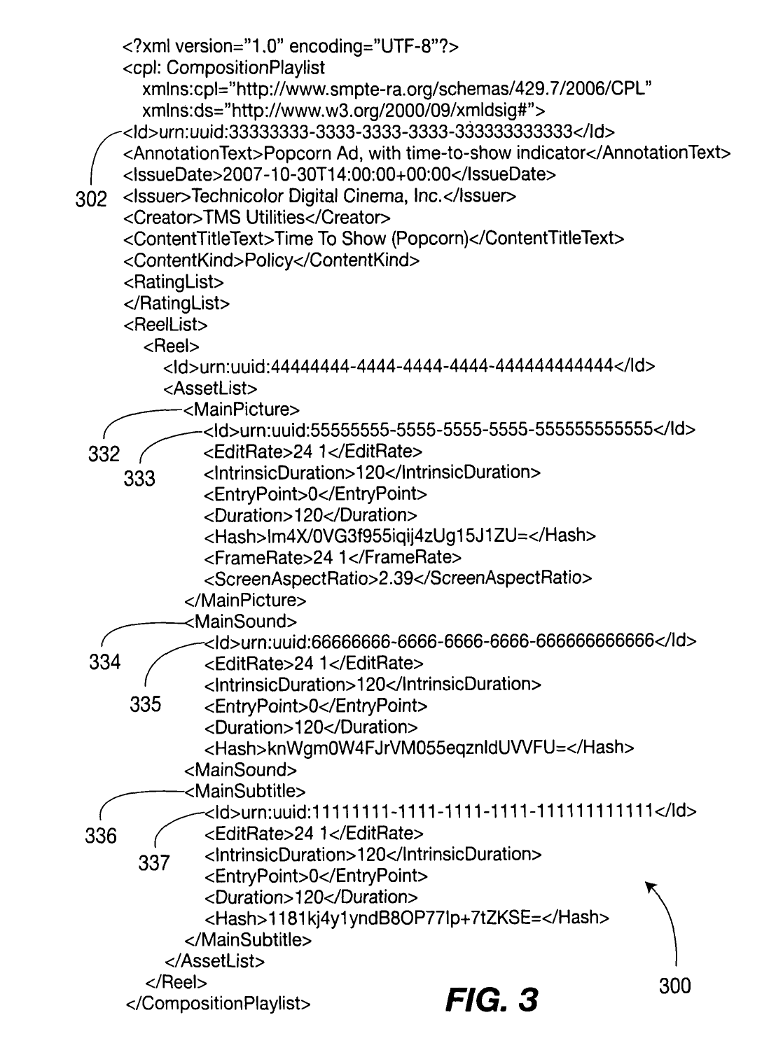

FIG. 3 shows CPL data 300 including the preferred implementation of CPL 230. Those skilled in the art will recognize the format of data 300 as conforming to SMPTE standard 429-7. However, as noted above, it is to be appreciated that the present principles are not limited to any particular format. A universally unique identifier (UUID) 302 occurs in CPL data 300 to define the UUID by which CPL 230 will be referenced. This is the reference by which SPL 210 can unambiguously identify CPL 230. Alternatively, CPL 230 can be identified in SPL 210 by a separate UUID that may be called out in CPL data 300 as the ContentVersion identifier (not shown).

Within CPL data 300 are picture element 332, audio element 334, and subtitle element 336. Those skilled in the art will recognize that extensible markup language (XML) data, an element that begins as does 332 with an angle-bracketed tag such as “MainPicture” ends with an angle-bracketed closing tag “/MainPicture”. These elements identify the corresponding picture track file 232, audio track file 234, and subtitle track file 236 using the UUIDs 333, 335, and 337, respectively. Other well-known metadata is provided. The association between these UUIDs and the corresponding files is provided to server 110 at ingest time 272 and is subsequently tracked by server 110.

Referring now to FIG. 4A, the subtitle track file data 400 of the present principles is shown. This subtitle track file is identified by the UUID 402 which matches the UUID 337 in the subtitle element 336 of CPL data 300, and so subtitle track file data 400 is the subtitle track data referenced by CPL data 300 in subtitle element 336.

In this exemplary file, there are six discrete subtitle elements: 434, 436, 438, 440, 442, and 444.

Subtitle elements 434, 436, and 438 operate as follows: each identifies a time interval relative to the playout of CPL 230 during which the corresponding text should appear. Also, a location of the text on screen 130 is described. Subtitle 434 defines that the text 134′ should appear one-half of a second into the playout of CPL 230 at the location of word 134. One-half second later, subtitle 436 shows text 136′ at the location of word 136. One-half second after that, subtitle 436 ends and is replaced by subtitle 438 which shows text 136″ and 138′ at the locations of words 136 and 138, respectively. The effect to the audience is that the words “There's still time:” appear at half-second intervals. If desired, further metadata (not shown) can be provided so that these words fade in gradually. Hence, one or more special effects may be applied to the text. Such special effects may include, but are not limited to, fading, flashing/strobing (changing intensity), changing one or more colors of the text, and so forth.

Subtitles 440, 442, and 444 each provide text to be displayed as time remaining 140. The text is updated each second, since subtitles 440, 442, and 444 begin at consecutive seconds beginning two seconds into the playout of CPL 230, and each lasts for one second. If the subtitle implementation of projector 120 is not sufficiently responsive, a less frequent update may be specified to accommodate the shortcoming.

However, even though the subtitles 440, 442, and 444 are to provide the text to be displayed as time remaining 140, the astute reader will note that the text present in subtitle track file data 400 at location 140′ and at locations 140″ does not resemble the display of time remaining at location 140. Instead, the text present is an XML comment of the form associated with a server-side include, in this case, of a format known to be supported by Apache hypertext transfer protocol server, provided by the THE APACHE SOFTWARE FOUNDATION of Forest Hill, Md. Server-side includes of this format, or similar formats, are provided by most hypertext transfer protocol (HTTP) servers. The server-side include should be in a format supported by the HTTP service provided by digital cinema server 110.

In subtitle 440 at location 140′, the server-side include is an instruction to the HTTP service running on server 110 to execute a specific script in the Perl language named “TimeToNextShow” and to provide to that script the parameter of “00:00:02”. The result returned by that script would be a few characters of text such as “5:12” that represents an amount of time remaining before the feature starts. This is the text displayed as time remaining 140.

In subsequent subtitles 442 and 444, the server-side includes called out as 140″ both specify additional executions of the “TimeToNextShow” script, but with different parameters due to their deeper offset into the playout of CPL 230.

Note that for each of the server-side includes at locations 140′ and 140″, the parameter value is the value of the TimeIn parameter for the corresponding subtitle 440, 442, 444. The reason is that the projector is going to request subtitle track file 236 at notice pre-fetch time 282. If the script TimeToNextShow did not accept a parameter, then at the time that subtitle track file data 400 was processed by server 110 and supplied to projector 120, each of the three occurrences of the TimeToNextShow script would evaluate to the same text value. Instead, the script can perform the following steps: (a) note the UUID 402 of CPL 230; (b) find a match for UUID 402 in SPL 210; (c) determine the interval between the start of CPL 230 in SPL 210 and the start of the feature CPL 260; (d) subtract from the interval the value of the parameter; and (e) return the resulting interval, i.e., the time remaining before the feature at the time the specific subtitle is to be displayed, as a text string, preferably in a M:SS (minutes and seconds) format.

The resulting text provided by the script is substituted for the entirety of the XML comment providing the server-side include.

Of course, it is to be appreciated that other server-side include forms may be used. In FIG. 4B, subtitle 450 (which would replace subtitle 434, 436, and 438) displays the explicit text “Show starts at” and the server-side include appends a few characters of text representing the value of the environment variable “SHOWTIME” on server 110. Such an environment variable would be available from the schedule (not shown) on which server 110 is operating. A second and a half later, a second subtitle 452 is added to the display (which would replace subtitles 440, 442, and 444) which provides the explicit text “Time now is” and the server-side include which executes a Linux command to print the current time in H:MM:SS format. In this example, the current time does not change once displayed, and the time presented will substantially be notice prefetch time 282, which is when server 110 will be processing subtitle track file 236 in response to the request by projector 120.

In FIG. 4C, timed text subtitle 440 is replaced by subpicture subtitle 440′ in which no server-side include is necessary. Instead, subtitle 440′ provides UUID 460 which tells projector 120 that it will need to request a subpicture PNG file. The subtitle track file data 400 with subtitle 440′ replacing subtitle 440 is an embodiment of subtitle track file 236′, and UUID 460 will correspond to dynamic subpicture 238.

In this embodiment, when projector 120 requests the file for UUID 460, server 110 fulfills that request by running a program associated with UUID 460 that returns a subpicture PNG file as its result. This resulting file is provided by server 110 to projector 120 in response to the request. A program corresponding to this implementation could carry out the calculations previously described, or a similar calculation that returns a value substantially representative of the time remaining. The calculation result would then be processed by a text renderer and the resulting image of text on a transparent background field would be encoded as a PNG file and returned to projector 120. This PNG file would be used as the source of a portion of the image displaying time remaining 140.

In a more embellished embodiment, the text in the PNG display of the time remaining could be replaced or accompanied by an image of an analog clock (not shown) showing graphically the number of minutes and fraction thereof remaining.

Other messages can be included by server 110, such as the status of concession lines (“Concession lines are short! No waiting!”) or real-time sports scores (“UCLA 21, USC 0”) scrapped off of external web sites or subscription news feeds.

A user interface (not shown) can be provided at TMS 150. Personalized messages, such as those previously mentioned, can be entered and assigned to variables in the system. The CPL (not shown) for a pre-built, appropriately themed composition would be manually included in the show playlist. For instance, a theatergoer wishes to celebrate her husband's birthday. The theatergoer selects a specific “Happy Birthday” composition from a selection of special event compositions. The theater manager incorporates the CPL corresponding to the theatergoer's selection into show playlist and the composition assets are ingested (if not already). Further, the theater manager solicits appropriate personalized text for inclusion in the celebratory composition, and the text is entered as the value of a variable WHOSE_BIRTHDAY to which the celebratory composition will refer, much as the value of the variable SHOWTIME was referenced in subtitle 450. In this way, a CPL can be personalized to wish a happy birthday to “Kerry” by setting WHOSE_BIRTHDAY=“Kerry”. Alternatively, such a personalized composition can be implemented by a CPL that requests a subpicture which server 110 computes on the basis of WHOSE_BIRTHDAY.

In an alternative embodiment, server 110 does not have server-side includes enabled, and instead the XML comment embodying the include is passed to projector 120 to be interpreted by projector 120 before being used for display. An example of such functionality is “client-side includes” or other script function. Such functions are commonly implemented by the recipient of an XML file. While comment-embedded functions may be used as with server-side includes, a more common form is to use script tags to embed an operation in the subtitle track file data. A suitable and common language for such embedding is JavaScript. Such an embodiment would require the projector 120 to interpret JavaScript.

In a case where a digital cinema server 110 has a more predictable computational burden and excess processing power than the digital cinema projector 120, especially when handling subtitle overlays, it is preferable to allocate the burden for dynamic manipulations to the server.

In some implementations, subtitle rendering and overlay on the picture essence is performed by the server, and the projector has no participation in the subtitle rendering or overlay process. The projector merely displays the server-overlaid images provided via connection 114. The present principles also apply to the processing of subtitle track files or the dynamic creation of subpicture files in such an embodiment.

In another embodiment, at or near prep-suite time 280, but no later than the response of server 110 to the request at notice prefetch time 282, server 110, the TMS 150, or another entity (not shown) could provide an updated version of subtitle track file 236, wherein an external program generates a complete subtitle track file 236 that has counting down text such as “5:12”, “5:11”, and “5:10” in lieu of the server-side includes in subtitles 440, 442, and 444, respectively. Such an updated version of subtitle track file is generated by a process that maintains the necessary elements of the subtitle track file, including spatial and time critical aspects of the file. For example, such a dynamically generated subtitle track file might be referred to within CPL data 300 and the UUID 337 would be recognized by the server 110 as a call to generate and return a fresh version of the subtitle track file data 400 by a mechanism other than server-side includes. Such an implementation is readily understood by one of ordinary skill in this and related arts, and is not substantially different in the computational burden placed on server 110 than the preferred embodiment described herein.

Of course, given the teachings of the present principles provided herein, other variations are also readily understood and contemplated by one of ordinary skill in this and related arts, while maintaining the spirit of the present principles. If a message is to be included asserting that “Concession lines are short!” a corresponding PNG subpicture can be created from a digital image, for example from a network accessible camera (i.e., a “web-cam”, not shown) overlooking the concession stand queues. Server 110 obtains the digital image and processes the digital image as needed. Alternatively, another device, such as the TMS can periodically access the web-cam (not shown) and format an image taken with the camera into the appropriate scale and aspect ratio(s) called for by the various auditoriums. These images could be updated occasionally (e.g., one per minute) and left where they can be accessed by server 110, or periodically pushed by the TMS 150 to storage 112.

A similar implementation could be used to provide an image of individuals appropriate to messages such as “Sylvain: Tonight's Manager On Duty” or “This auditorium cleaned with pride by: Mark” to attribute the operation and maintenance of the theater to those responsible.

In still another embodiment, the presentation of dynamically generated subtitles may not be displayed in the image displayed on screen 130 by projector 120. Instead, dynamically generated displays may be presented on an additional display device (not shown), such as an LED multi-line character display located near the screen such as the SUPERTITLE supplied by DIGITAL TECH SERVICES of Portsmouth, Va., or written on or near the screen by a laser projection system such as the CINEMA SUBTITLING SYSTEM supplied by DIGITAL THEATER SYSTEMS of Agoura Hills, Calif. In such an embodiment, communication from server 110 to the additional display device (not shown) would be via network 118 or other direct or wireless connection. Server 110 would react to commands in subtitle track file 236 or other analogous files providing a list of events and the times at which they should occur, by providing the appropriate text for display by the additional display device at substantially the time when the display of the text is appropriate. In still an alternative embodiment, the projector 120 may provide text to the additional display device as a response to a client-side include or script.

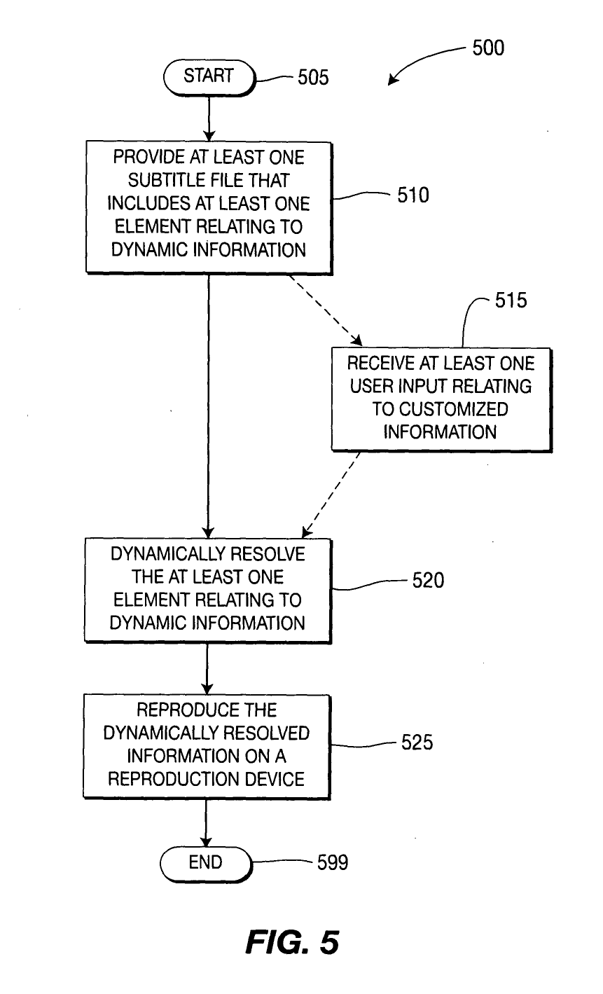

Referring to FIG. 5, an exemplary method 500 for displaying dynamic information in a digital display system is shown.

The method 500 includes a start block 505 that passes control to a function block 510. The function block 510 provides at least one subtitle file that includes at least one element relating to the dynamic information, and passes control to a function block 520. The function block 520 dynamically resolves the element (i.e., in some embodiments, provides a solution by acting on and replacing an instruction or comment in the subtitle file) relating to the dynamic information on the basis of dynamic values such as the current time or customized information. The specific operation or action required for dynamically resolving a given element depends on the implementation details. For example, such operations may include expanding a server-side include, generating or selecting an appropriate subpicture file as described above, among others. Upon completing the function in block 520, control is passed to a function block 525, which reproduces (e.g., visually and/or audibly) the resolved form of the subtitle file on a reproduction device (e.g., one or more screens and/or one or more speakers, and so forth). For example, the reproduction of the dynamically generated information may be done as a part of a presentation of content by a digital display system, e.g., prior to the showing of a movie in a cinema. Upon completion of function block 525, control is passed to an end block 599.

In an alternative embodiment, the dynamic information to be reproduced contains customized or personalized information, which may be provided by a user. This is shown in FIG. 5, in which an optional function block 515 receives at least one user input relating to the customized information, and the customized information is used in function block 520 for dynamically resolving the at least one element associated with the dynamic information. The dynamically resolved information is then reproduced (see function block 525). Referring back to the example in FIG. 1, the display manager 177 may be used for receiving the user input, and customized information may be reproduced by the digital display system on screen 130 and/or one or more other screens and/or speakers (not shown)

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1. A method for use in a digital display system, comprising:
generating dynamic information for display by processing a subtitle file including at least one element that changes dynamically.

2. The method of claim 1, wherein the dynamic information includes customized information, and the method further comprises receiving at least one user input relating to the customized information.

3. The method of claim 1, wherein the at least one element identifies a time interval, relative to a playout of scheduled content, during which the dynamic information is to be displayed, and further identifies a location on a screen of the digital display system at which the dynamic information is to be displayed.

4. The method of claim 1, wherein the at least one element identifies at least one parameter of a special effect applied to the dynamic information during the display of the dynamic information.

5. The method of claim 1, wherein the at least one element comprises at least one server-side include.

6. The method of claim 1, wherein the dynamic information relates to a movie played out by the digital display system.

7. The method of claim 1, wherein the dynamic information identifies at least one person in attendance of a movie played out by the digital display system.

8. The method of claim 7, wherein the at least one person comprises at least one of a customer or an employee.

9. The method of claim 1, wherein the dynamic information comprises at least one message identifying a time remaining until a scheduled movie is to commence being played out by the digital display system.

10. The method of claim 1, wherein the at least one element comprises at least one script element for dynamically calculating a value that is displayed as at least part of the dynamic information.

11. The method of claim 1, wherein the subtitle file is comprised in a composition playlist.

12. An apparatus for use in a digital display system, comprising:
a display manager for generating dynamic information for display by processing a subtitle file including at least one element that changes dynamically.

13. The apparatus of claim 12, wherein the dynamic information includes customized information and the display manager is configured for receiving at least one user input relating to the customized information.

14. The apparatus of claim 12, wherein the at least one element identifies a time interval, relative to a playout of scheduled content, during which the dynamic information is to be displayed, and further identifies a location on a screen of the digital display system at which the dynamic information is to be displayed.

15. The apparatus of claim 12, wherein the at least one element identifies at least one parameter of a special effect applied to the dynamic information during the display of the dynamic information.

16. The apparatus of claim 12, wherein the at least one element comprises at least one server-side include.

17. The apparatus of claim 12, wherein the dynamic information relates to a movie played out by the digital display system.

18. The apparatus of claim 12, wherein the dynamic information identifies at least one person in attendance of a movie played out by the digital display system.

19. The apparatus of claim 18, wherein the at least one person comprises at least one of a customer or one employee.

20. The apparatus of claim 12, wherein the dynamic information comprises at least one message identifying a time remaining until a scheduled movie is to commence being played out by the digital display system.

21. The apparatus of claim 12, wherein the at least one element comprises at least one script element for dynamically calculating a value that is displayed as at least part of the dynamic information.

22. The apparatus of claim 12, wherein the subtitle file is comprised in a composition playlist.
